(19) United States
(12) Patent Application Publication
(10) Pub. No.: US 2026/0245374 A1
(43) Pub. Date: Aug. 20, 2026

(54) ON-VEHICLE IMAGE PROCESSING DEVICE AND IMAGE PROCESSING METHOD FOR ON-VEHICLE EQUIPMENT

(71) Applicant: Astemo, Ltd., Chiyoda-ku, Tokyo (JP)

(72) Inventors: Takakiyo YASUKAWA, Hitachinaka-shi, Ibaraki (JP); Kota IRIE, Hitachinaka-shi, Ibaraki (JP); Hirotomo SAI, Hitachinaka-shi, Ibaraki (JP)

(73) Assignee: Astemo, Ltd., Chiyoda-ku, Tokyo (JP)

(21) Appl. No.: 19/161,865

(22) PCT Filed: Jun. 20, 2023
(86) PCT No.: PCT/JP2023/022691

§ 371 Date: Sep. 3, 2025

(51) Int. Cl. G06V 20/58

(52) U.S. Cl. CPC G06V 20/58

(57) ABSTRACT

An on-vehicle image processing device includes a first image correction unit that corrects an image deviation of an image captured by a second camera having a resolution lower than or equivalent to a resolution of a preset first camera with reference to an image captured by the first camera among a plurality of imaging units mounted around a vehicle, and a first stereo recognition processing unit that performs stereo recognition processing using the image captured by the first camera and the image captured by the second camera corrected by the first image correction unit. Further, a second stereo recognition processing unit that performs stereo recognition processing using the image captured by the second camera and an image obtained by correcting an image captured by a third camera is included.

### TECHNICAL FIELD

The present invention relates to an on-vehicle image processing device and an image processing method for on-vehicle equipment.

### BACKGROUND ART

In a vehicle such as an automobile, a sensing technology for detecting an object and a person around the vehicle by photographing the surroundings with cameras mounted on the vehicle is being developed in order to perform automatic driving and driving support.

One of the methods for recognizing an object from images captured by cameras is stereo processing that captures the same object by two cameras. By performing the stereo processing, it is possible to perform distance measurement to detect the distance to the photographed object based on the images captured by the two cameras. In order to perform the distance measurement, it is needed to correctly adjust photographing positions and photographing angles of the two cameras and capture images in a state where there is no axial deviation between the two cameras. If the adjustment is not correct, matching accuracy of the two images, that is, distance measurement performance is deteriorated.

PTL 1 describes a technique for realizing cost reduction while securing long-distance matching accuracy with telephoto lenses by executing stereo processing using only central portions of images regarding a distant place and using wide-angle regions of peripheral portions regarding a vicinity place in an on-vehicle stereo camera device using a stereo camera.

### CITATION LIST

### Patent Literature

PTL 1: JP 2019-178871 A

### SUMMARY OF INVENTION

### Technical Problem

Meanwhile, the number of on-vehicle cameras mounted on one vehicle tends to increase. In other words, with the advancement of the automatic driving function and the driving support function, there is a tendency to dispose a large number of cameras such as side cameras that capture side views from the vehicle, in addition to a front camera that captures a front view from the vehicle and a rear camera that captures a rear view from the vehicle. Here, if each camera is a stereo camera, twice as many cameras are needed, which is not preferable because the configuration becomes complicated and the cost increases.

For this reason, it has been studied to perform the stereo processing and the distance measurement processing by using only overlap areas of images captured by the plurality of cameras having different angles of view. According to such a configuration, the distance measurement processing can be performed by the stereo processing without substantially increasing the number of on-vehicle cameras.

In a case where the stereo processing is performed with such a configuration, there is a problem that a range in which distance can be measured by the stereo processing is limited unless how a plurality of cameras is combined to perform the stereo processing is appropriately selected. Although specific contents of such a problem will be described in an embodiment described later, a problem caused by performing appropriate stereo processing from captured images having different angles of view cannot be basically solved by conventional stereo processing in which two cameras capture substantially the same range.

Note that PTL 1 describes that stereo processing is performed from a partial region called a central portion of an image, but the number of target cameras is only two, and this invention is not applicable to a case where more cameras are mounted on a vehicle and a plurality of sets of stereo processing is performed.

An object of the present invention is to provide an on-vehicle image processing device and an image processing method for on-vehicle equipment capable of performing highly accurate distance measurement using a plurality of on-vehicle cameras.

### Solution to Problem

In order to solve the above problem, the configuration described in the claims, for example, is adopted.

The present application includes a plurality of means for solving the above problems, and an example thereof is an on-vehicle image processing device including an image acquisition unit that acquires images captured by a plurality of cameras mounted around a vehicle, a first image correction unit that corrects an image deviation of an image captured by a second camera having a resolution lower than or equivalent to a resolution of a preset first camera among the plurality of cameras with reference to an image captured by the first camera among the plurality of cameras, a first stereo recognition processing unit that performs stereo recognition processing using the image captured by the first camera and the image captured by the second camera corrected by the first image correction unit, a second image correction unit that corrects an image deviation of an image captured by a third camera having a resolution lower than or equivalent to the resolution of the second camera with reference to the image captured by the second camera, and a second stereo recognition processing unit that performs stereo recognition processing using the image captured by the second camera and the image captured by the third camera corrected by the second image correction unit.

### Advantageous Effects of Invention

According to the present invention, since processing is performed by appropriately determining an image to be a reference when a plurality sets of stereo recognition processing is performed, each stereo processing can be performed without increasing a cumulative error and without increasing the load of the stereo recognition processing. Therefore, distance measurement processing of an object or the like around the vehicle can be performed with high accuracy.

Problems, configurations, and effects other than those described above will be clarified by the following description of embodiments.

### BRIEF DESCRIPTION OF DRAWINGS

FIG. 1 is a configuration diagram illustrating an example of an on-vehicle image processing device according to an embodiment of the present invention.

FIG. 2 is a configuration diagram illustrating an example of an image correction unit of the on-vehicle image processing device according to the embodiment of the present invention.

FIG. 3 is a configuration diagram illustrating an example of an image selection unit of the on-vehicle image processing device according to the embodiment of the present invention.

FIG. 4 is a diagram illustrating an example of imaging ranges of images to be processed by the on-vehicle image processing device according to the embodiment of the present invention.

FIG. 5 is a diagram illustrating an example of a stereo combination range of each image when stereo processing is performed by the on-vehicle image processing device according to the embodiment of the present invention.

FIG. 6 is a diagram illustrating an example of image combination (camera combination) of stereo processing by the on-vehicle image processing device according to the embodiment of the present invention.

FIG. 7 is a diagram illustrating an example of reference images and corrected images in the stereo processing by the on-vehicle image processing device according to the embodiment of the present invention.

FIG. 8 is a diagram illustrating an example of a principle of image correction by the on-vehicle image processing device according to the embodiment of the present invention.

FIG. 9 is a diagram illustrating a conventional example in a case where a plurality of stereos is performed.

### DESCRIPTION OF EMBODIMENTS

Hereinafter, an embodiment of the present invention will be described with reference to the accompanying drawings.

### Configuration of On-Vehicle Image Processing Device

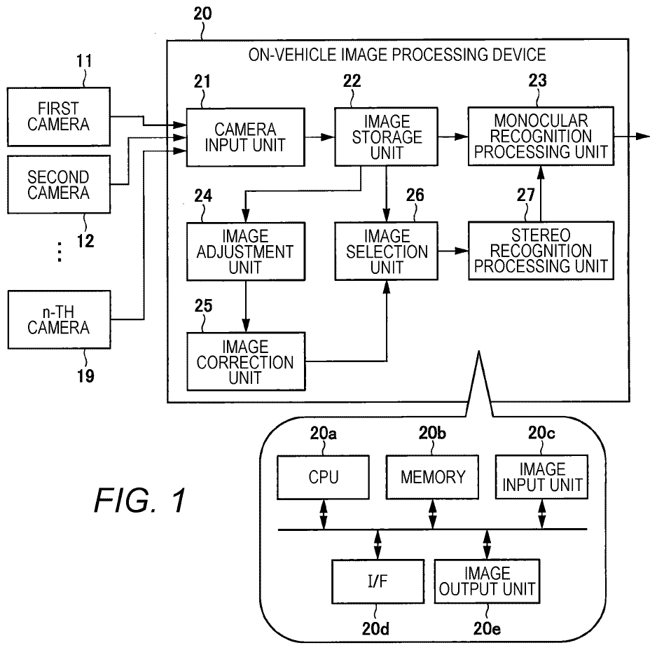

FIG. 1 illustrates an example of an overall configuration of an on-vehicle image processing device according to the present embodiment.

An on-vehicle image processing device 20 according to the present embodiment is mounted on a vehicle such as an automobile, and processes images of seven cameras 11 to 17 which are a plurality of imaging units installed in the vehicle. Although installation conditions of the seven cameras 11 to 17 in the vehicle will be described later, each of the cameras 11 to 17 is a video camera that performs imaging at a constant frame rate, and at least a part of a range captured by each camera 11 to 17 overlaps with a range captured by another camera in the cameras 11 to 17. The number of the cameras (imaging units) 11 to 17 is seven, but this is merely an example, and other numbers may be used.

The on-vehicle image processing device 20 includes an image acquisition unit 21, an image storage unit 22, subject recognition processing unit 23, an image adjustment unit 24, an image correction unit 25, an image selection unit 26, and a stereo recognition processing unit 27.

The image acquisition unit 21 performs image acquisition processing of image signals captured by the seven cameras 11 to 17. The image signal from each camera acquired by the image acquisition unit 21 is supplied to the image storage unit 22.

The image storage unit 22 temporarily stores the supplied captured images of the seven cameras 11 to 17.

The subject recognition processing unit 23 performs recognition processing of a subject (object) around the vehicle from the captured image from each camera 11 to 17, and outputs information of the recognized object. When the recognition processing is performed, information on the distance of the recognized object from the vehicle body is added based on the information obtained by stereo recognition processing in the stereo recognition processing unit 27. Based on a change in the distance, the speed may be recognized.

The image adjustment unit 24 performs adjustment processing to make the captured image from each camera 11 to 17 an appropriate image. The adjustment processing includes various types of image processing such as size adjustment and image luminance correction for appropriately performing selection in the image selection unit 26, recognition in the stereo recognition processing unit 27, and the like. As one of the adjustments by the image adjustment unit 24, there is detection processing of the deviation amount of each captured image.

The image correction unit 25 performs processing of correcting the deviation of each image based on the deviation detection in the image adjustment unit 24. The processing of correcting the deviation of the image is, for example, correction of the deviation of pitching, roll, and yaw, and specifically, vertical offset correction, horizontal offset correction, and angle correction are performed. In the present embodiment, since multiple sets of recognition processing are performed in the stereo recognition processing unit 27, correction of multiple images is performed simultaneously.

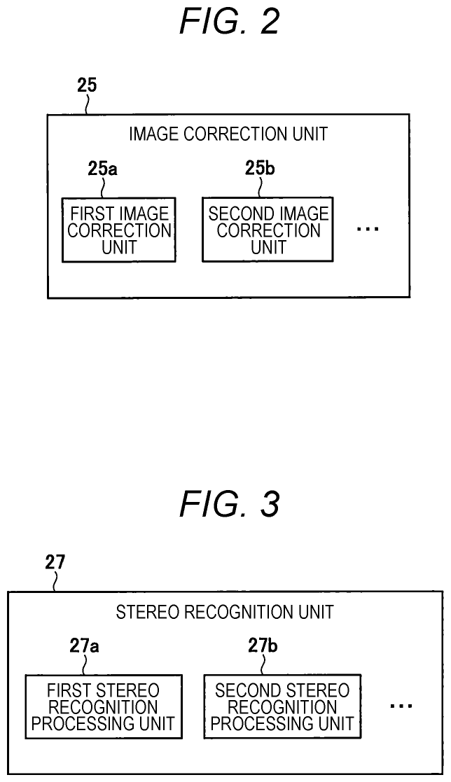

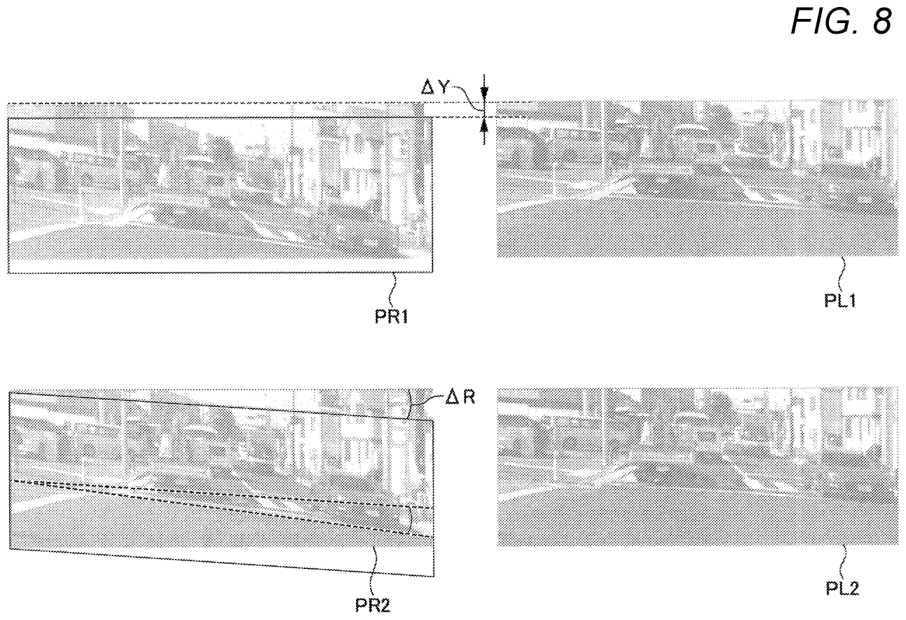

In other words, as illustrated in FIG. 2, in the image correction unit 25, a plurality of sets of processing units including a first image correction unit 25a, a second image correction unit 25b, and the like are provided, and correction (first image correction processing, second image correction processing, third image correction processing, and the like) of different images is performed by the respective image correction units 25a, 25b, and the like. A specific example of the correction processing performed by the image correction unit 25 will be described later with reference to FIG. 8.

The image selection unit 26 performs image selection processing for stereo recognition using the image corrected by the image correction unit 25 and the image stored in the image storage unit 22. According to the present embodiment, since a plurality of sets of recognition processing is performed in stereo recognition processing unit 27, a plurality of images is simultaneously selected.

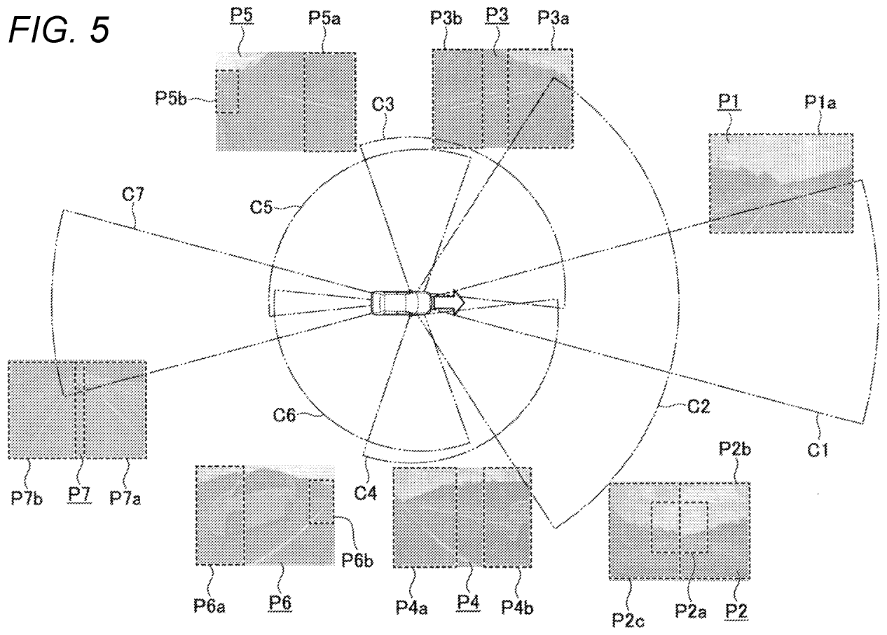

In other words, the image selection unit 26 also includes a configuration in which a plurality of sets of processing units that perform selection is provided, and each image selection unit selects a different image. A specific example of image selection in the image selection unit 26 will be described later with reference to FIG. 5.

The stereo recognition processing unit 27 performs recognition processing of an object in the image from the two images selected by the image selection unit 26, and performs distance measurement processing of recognizing the distance from the vehicle to the object based on the disparity between the two images. In other words, as illustrated in FIG. 3, the stereo recognition processing unit 27 also includes a first stereo recognition processing unit 27a, a second stereo recognition processing unit 27b, a third stereo recognition processing unit 27c, a fourth stereo recognition processing unit 27d, and the like, and is configured to simultaneously perform a plurality of sets of stereo recognition processing. However, in FIG. 3, only the first stereo recognition processing unit 27a and the second stereo recognition processing unit 27b are illustrated, and the third stereo recognition processing unit and the fourth stereo recognition processing unit are not illustrated.

Note that the simultaneous execution of the stereo recognition processing here indicates that processing is performed almost simultaneously, and in addition to the configuration in which processing is performed simultaneously in parallel by the processing units of a plurality of systems as illustrated in FIGS. 2 and 3, each set of processing may be sequentially executed in a time division manner by a processing unit (for example, one stereo recognition processing unit) of a limited system within one frame period to which an image from a camera is supplied. Therefore, the plurality of image correction units and the plurality of stereo recognition processing units as illustrated in FIGS. 2 and 3 exist when viewed from the flow of the image signal to be processed, and the plurality of image correction units and the plurality of stereo recognition processing units do not necessarily exist in terms of the hardware configuration.

The distance information obtained by the distance measurement processing is supplied to the subject recognition processing unit 23.

The on-vehicle image processing device 20 illustrated in FIG. 1 can be configured by, for example, a computer. In other words, as illustrated in the lower part of FIG. 1, the on-vehicle image processing device 20 can be configured by a computer in which a central processing unit (CPU) 20a, a memory 20b, an image input unit 20c, an interface 20d, and an image output unit 20e are connected by a bus line.

The CPU 20a is a processor that executes the image recognition processing by causing the memory 20b to constitute each processing unit by executing the program stored in the memory 20b. The processing units configured in the memory 20b under the control of the CPU 20a are the subject recognition processing unit 23, the image adjustment unit 24, the image correction unit 25, the image selection unit 26, and the stereo recognition processing unit 27 described above.

The memory 20b serves as a storage unit as a work area for executing arithmetic processing under the control of the CPU 20a and a storage unit for storing programs and various data.

The image input unit 20c performs input processing of the images captured by the cameras 11 to 17.

The interface 20d exchanges information with another control device (not illustrated) in the vehicle. For example, information of objects and distances around the vehicle obtained by the on-vehicle image processing device 20 is transmitted to another control device.

The image output unit 20e outputs the image processed by the on-vehicle image processing device 20 in order to display the image on a display unit (not illustrated) in the vehicle.

Note that the configuration in which the on-vehicle image processing device 20 performs arithmetic processing based on an installed program is an example, and other configurations may be adopted. For example, a part or all of the on-vehicle image processing device 20 may be realized by dedicated hardware such as a field programmable gate array (FPGA) or an application specific integrated circuit (ASIC).

### Example of Angles of View of Cameras Mounted on Vehicle

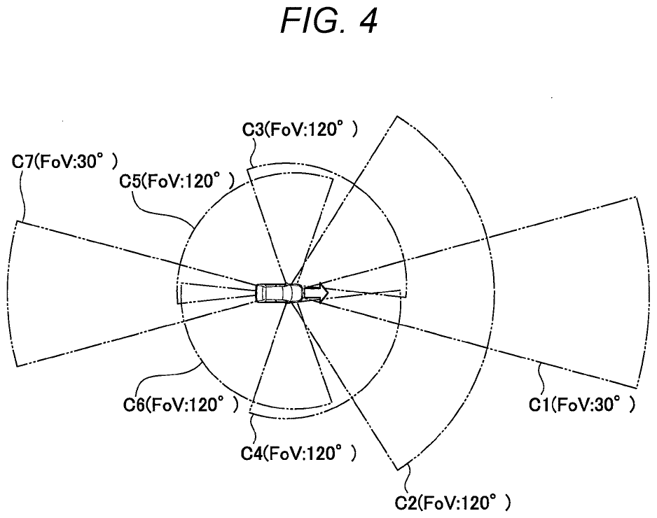

FIG. 4 illustrates an example of imaging angles of the seven cameras 11 to 17 whose captured images are supplied to the on-vehicle image processing device 20 according to the present embodiment.

Regarding the vehicle illustrated in the center of FIG. 4, the right side is a front side and the left side is a rear side. The upper side in FIG. 4 is a left side, and the lower side in FIG. 4 is a right side. The imaging angles of the seven cameras 11 to 17 will be described below.

The first camera 11 is a front narrow-angle camera that captures an image in a range of a front narrow-angle C1 of the vehicle. The front narrow-angle here is, for example, 30°. The first camera 11 that captures an image in the range of the front narrow-angle C1 captures an image having the largest number of pixels and a high resolution among the Seven cameras 11 to 17.

The second camera 12 is a front wide-angle camera that captures an image in a range of a front wide-angle C2 of the vehicle. The front wide-angle here is, for example, 120°. The second camera 12 that captures the range of the front wide-angle C2 captures an image having a number of pixels same as or smaller than that of the first camera 11 and a resolution same as or lower than that of the first camera 11.

The third camera 13 is a side-front camera that captures an image in a range of a side-front C3 on the left side of the vehicle. Here, the side-front is, for example, 120°.

The fourth camera 14 is a side-front camera that captures an image in a range of a side-front C4 on the right side of the vehicle. Here, the side-front is, for example, 120°.

The third camera 13 and the fourth camera 14 capture images having a number of pixels same as or smaller than those of the first camera 11 and the second camera 12 and a resolution same as or lower than that of the first camera 11. Further,

The fifth camera 15 is a side-rear camera that captures an image in a range of a side-rear C5 on the left side of the vehicle. The side-rear here is, for example, 120°.

The sixth camera 16 captures an image in a range of a side-rear C6 on the right side of the vehicle. The side-rear here is, for example, a side-rear camera with 120°.

The fifth camera 15 and the sixth camera 16 capture images having a number of pixels same as or smaller than those of the first camera 11 and the second camera 12 and a resolution same as or lower than that of the first camera 11. In addition, even in a case where the fifth camera 15 and the sixth camera 16 are compared with the third camera 13 and the fourth camera 14, the fifth camera 15 and the sixth camera 16 capture images having a number of pixels Same as or smaller than those of the third camera 13 and the fourth camera 14, or images having a resolution same as or lower than those of the third camera 13 and the fourth camera 14. Further, even when compared with the seventh camera 17 (rear camera) described below, the fifth camera 15 and the sixth camera 16 capture images having a number of pixels Same as or smaller than that of the seventh camera 17 and having a resolution same as or lower than that of the seventh camera 17.

The seventh camera 17 is a rear camera that captures an image in a range of a rear C7 of the vehicle. Here, the rear is, for example, 30°.

As described above, according to the present embodiment, the surroundings of the vehicle at 360° in the horizontal direction are captured by the seven cameras 11 to 17. Here, as illustrated in FIG. 4, each of the imaging ranges C1 to C7 of the cameras 11 to 17 overlaps with at least part of the imaging ranges of the other cameras. According to the present embodiment, stereo processing is performed using the region where the imaging ranges overlap.

### Example of Combination for Performing Stereo Processing

FIG. 5 illustrates an example of images on which the stereo processing is performed.

In an image P1 obtained by capturing the front narrow-angle C1 with the first camera 11, an entire imaging range overlaps with an imaging range of an image P2 obtained by capturing the front wide-angle C2 with the second camera 12. The on-vehicle image processing device 20 performs a set of stereo processing (first stereo recognition processing) using substantially an entire range P1a of the image P1 of the front narrow-angle C1 and substantially a center range P2a of the image P2 of the front wide-angle C2.

In the image P2 obtained by capturing the front wide-angle C2 by the second camera 12, a range P2b in a right half overlaps in an imaging range with a range P4a in a left half of an image P4 of the side-front C4 of the fourth camera 14. The on-vehicle image processing device 20 performs a set of stereo processing (second stereo recognition processing) using the range P2b of the right half of the front wide-angle C2 and the range P4a of the left half of the right side-front C4.

In addition, in the image P2 obtained by capturing the front wide-angle C2 by the second camera 12, a range P2c of a left half overlaps in an imaging range with a range P3a of a right half of an image P3 of the side-front C3 of the third camera 13. The on-vehicle image processing device 20 performs a set of stereo processing (third stereo recognition processing) using the range P2c of the left half of the front wide-angle C2 and the range P3a of the right half of the left side-front C3.

In addition, in the image P4 of the side-front C4 on the right side of the fourth camera 14, a range P4b at a right end overlaps in an imaging range with a left end P6a of an image P6 of the side-rear C6 of the sixth camera 16. The on-vehicle image processing device 20 performs a set of stereo processing (fourth stereo recognition processing) using the range P4b at the right end of the right side-front C4 and the left end P6a of the right side-rear C6.

In addition, in the image P3 on the left side-front C3 of the third camera 13, a range P3b on a left end overlaps in an imaging range with a right end P5a of an image P5 on the left side-rear C5 of the fifth camera 15. The on-vehicle image processing device 20 performs a set of stereo processing (fifth stereo recognition processing) using the range P3b at the left end of the left side-front C3 and the right end P5a of the left side-rear C5.

Also, a part P6b at a right end of the image P6 on the side-rear C6 of the sixth camera 16 overlaps in an imaging range with a left half P7b of an image P7 on the rear C7 of the seventh camera 17. The on-vehicle image processing device 20 performs a set of stereo processing (sixth stereo recognition processing) using the part P6b of the right end of the image P6 of the side-rear C6 and the left half P7b of the image P7 of the rear C7.

Also, a part P5b of a left end of the image P5 on the side-rear C5 of the fifth camera 15 overlaps in an imaging range with a right half P1a of the image P7 on the rear C7 of the seventh camera 17. The on-vehicle image processing device 20 performs a set of stereo processing (seventh stereo recognition processing) using the part P5b of the right end of the image P5 of the side-rear C5 and the right half P7a of the image P7 of the rear C7.

Although not illustrated in FIG. 5, the imaging ranges partially overlap between the image P1 at the front narrow-angle C1 and the images P3 and P4 at the side-front C3 and C4. Therefore, stereo processing may be performed using these images.

The on-vehicle image processing device 20 simultaneously executes these stereo processing. However, the term “simultaneously” as used herein means that the processes are executed almost simultaneously, and the processes may be executed sequentially in a time division manner, for example.

In executing each stereo processing, in order to combine two images, it is needed to adjust so that the two images can be correctly stereoscopically processed by correcting, with a reference image captured by one camera, an image captured by another camera.

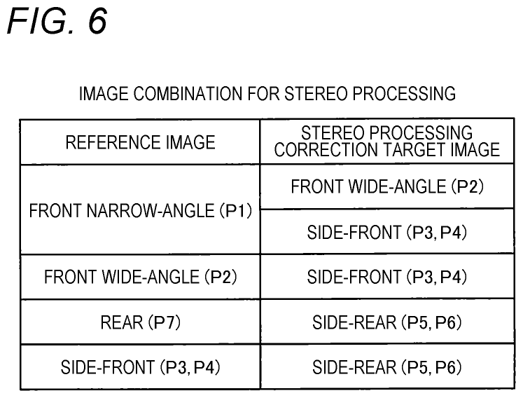

FIG. 6 illustrates an example of combination of reference images and correction target images when the on-vehicle image processing device 20 performs the image combination (camera combination) for the stereo processing. When the stereo processing (first stereo recognition processing) is performed on the image P1 with the front narrow-angle C1 and the image P2 with the front wide-angle C2, the image P1 with the front narrow-angle C1 captured by the first camera 11 is used as a reference. Then, the image P2 of the front wide-angle C2 captured by the second camera 12 is set as a correction target image for the stereo processing.

When the stereo processing (processing other than the first to seventh stereo recognition processing) is performed on the image P1 of the front narrow-angle C1 and the images P3 and P4 of the side-front C3 and C4, the image P1 of the front narrow-angle C1 captured by the first camera 11 is used as a reference. Then, the images P3 and P4 of the side-front C3 and C4 captured by the third camera 13 and the fourth camera 14 are set as correction target images for stereo processing. However, the stereo processing of combining the image P1 of the front narrow-angle C1 and the images P3 and P4 of the side-front C3 and C4 may not be executed.

When stereo processing (second stereo recognition processing and third stereo recognition processing) is performed on the image P2 of the front wide-angle C2 and the images P3 and P4 of the side-front C3 and C4, the image P2 of the front wide-angle C2 captured by the second camera 12 is used as a reference. Then, the images P3 and P4 of the side-front C3 and C4 captured by the third camera 13 and the fourth camera 14 are set as correction target images for stereo processing.

When stereo processing (sixth stereo recognition processing and seventh stereo recognition processing) is performed on the image P7 of the rear C7 and the images P5 and P6 of the side-rear C5 and C6, the image P7 of the rear C7 captured by the seventh camera 17 is used as a reference. Then, the images P5 and P6 of the side-rear C5 and C6 captured by the fifth camera 15 and the sixth camera 16 are set as correction target images for stereo processing.

When stereo processing (fourth stereo recognition processing and fifth stereo recognition processing) is performed on the images P3 and P4 of the side-front C3 and C4 and the images P5 and P6 of the side-rears C5 and C6, the images P3 and P4 of the side-front C3 and C4 captured by the fifth camera 15 and the sixth camera 16 are used as references. Then, the images P5 and P6 of the side-rear C5 and C6 captured by the fifth camera 15 and the sixth camera 16 are set as correction target images for stereo processing.

### Example of Correction Processing

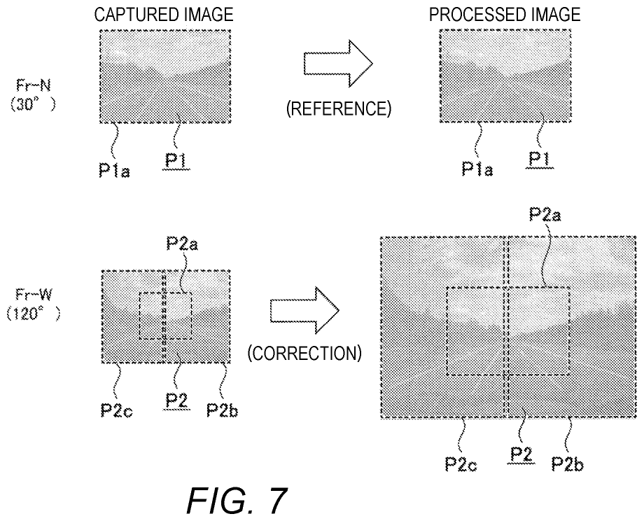

FIG. 7 illustrates processing of obtaining a reference image and a corrected image from the captured images when the first stereo recognition processing is performed on the image P1 of the front narrow-angle C1 and the image P2 of the front wide-angle C2.

In the first stereo recognition processing, since the image P1 of the front narrow-angle C1 is used as a reference, the captured image P1 is an image for stereo processing as it is, and almost the entire range of the captured image P1 is one image P1a when the stereo processing is performed.

Then, since the image P2 having the front wide-angle C2 is an image to be corrected in the first stereo recognition processing, offset correction and angle correction are performed so that the range P2a of the image to be extracted becomes the same as the range of the image P1a. In addition, correction processing is performed so as to be handled as an image having the same size as the one image P1a. When the sizes are adjusted, for example, the number of pixels in the range P2a of the image P2 may be increased by interpolation or the like.

FIG. 8 illustrates specific examples of offset correction and angle correction in the image correction unit 25.

For example, as illustrated in the upper part of FIG. 8, it is assumed that an offset by a predetermined amount ΔY occurs in the vertical direction in the two images PL1 and PR1 when the stereo processing is performed. At this time, roll correction of shifting the image PR1 to be corrected by a predetermined amount ΔY in the vertical direction is performed without correcting the reference image (the image PL1 in the example of FIG. 8).

In addition, although not illustrated, when there is a deviation in the left-right direction between the two images, the image PL1 serving as a reference is not corrected, and pitching correction is performed to shift the image PR1 to be corrected in the left-right direction by a predetermined amount ΔX.

In addition, as illustrated in the lower part of FIG. 8, it is assumed that an angular deviation occurs by a predetermined amount ΔR in the two images PL2 and PR2 when the stereo processing is performed. At this time, yaw deviation correction of rotating the image PR2 to be corrected by the predetermined amount ΔR is performed without correcting the reference image (the image PL2 in the example of FIG. 8).

### Effects of Processing According to Present Embodiment

As described above, when the stereo processing is performed by the plurality of cameras mounted on the vehicle, the error is not accumulated because the image serving as the reference and the image serving as the correction target are determined as described with reference to FIG. 6. In other words, in the first stereo recognition processing, the object recognition and the distance measurement by the preferable stereo processing can be performed by using the captured image of the first camera 11 (front narrow-angle camera) having the high resolution as a reference.

Since the second stereo recognition processing and the third stereo recognition processing are also based on the captured image of the second camera 12, preferable stereo processing can be performed.

In addition, since the fourth stereo recognition processing and the fifth stereo recognition processing are also based on the captured image of the third camera 13 or the fourth camera 14, preferable stereo processing can be performed.

On the other hand, in the sixth stereo recognition processing and the seventh stereo recognition processing, the captured image of the seventh camera 17 (rear camera) having a high resolution is used as a reference, so that the object recognition and the distance measurement by the preferable stereo processing can be performed.

Furthermore, in each stereo processing, as one image, the captured image obtained by the camera is used as the reference image as it is, and only the other image is used as the corrected image, so that it is possible to reduce the number of images temporarily stored in the image processing device 20 for correction, and the load at the time of image processing in the image processing device 20 is small.

### Comparative Example in Case Where Processing of Present Embodiment is not Performed

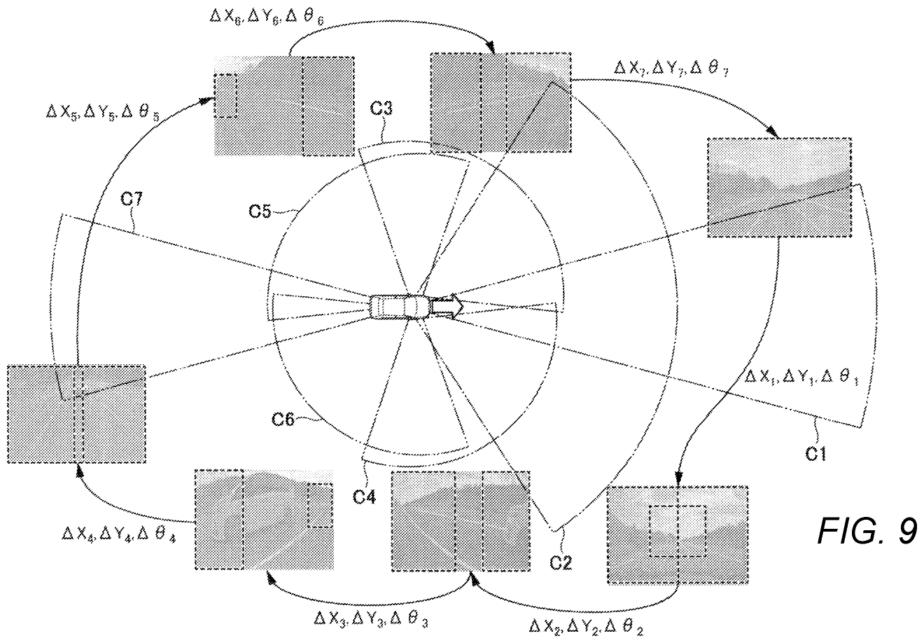

Here, in order to describe an effect that errors are not accumulated by performing the stereo processing according to the present embodiment, FIG. 9 illustrates processing of a case where a plurality of sets of conventional stereo processing is performed.

The example of FIG. 9 is an example of a case where the reference image for the stereo processing is sequentially one image. In other words, when the first stereo recognition processing is performed on the image of the front narrow-angle C1 and the image of the front wide-angle C2, the pitching ΔX₁, the roll ΔY₁, and the yaw 401 are corrected on the image of the front wide-angle C2.

When the third stereo recognition processing is performed on the image of the front wide-angle C2 and the image of the side-front C4, the pitching ΔX₂, the roll ΔY₂, and the yaw 402 are corrected on the image of the side-front C4 based on the image of the front wide-angle C2 corrected by the first stereo recognition processing.

When the fifth stereo recognition processing is performed on the image of the side-front C4 and the image of the side-rear C6, the pitching ΔX₃, the roll ΔY₃, and the yaw 403 are corrected on the image of the side-rear C6 based on the image of the side-front C4 corrected by the third stereo recognition processing.

In this manner, the correction is sequentially performed on the images of adjacent angles of view around the vehicle, and the correction is sequentially performed on the images around the vehicle. Then, when the second stereo recognition processing is performed on the image of the front wide-angle C2 and the image of the side-front C3 after one round of processing, the pitching ΔX₇, the roll ΔY₇, and the yaw 407 are corrected on the image of the front wide-angle C2 based on the image of the side-front C3.

At the time of the second stereo recognition processing, the correction ΔX₇, ΔY₇, and 407 are performed on the image of the front wide-angle C2 based on the corrected image of the side-front C3 accumulated by the correction in each previous stereo processing. Therefore, the range becomes narrower than the range in which the image of the front wide-angle C2 is used at the time of the third stereo recognition processing. In other words, the correction is cumulatively performed in order to perform the plurality of stereo processing, and as a result, an image having a low resolution is used, and the number of pixels of the imaging element of the camera cannot be effectively used.

On the other hand, according to the case of the present embodiment, the correction of the image is not cumulatively performed, and there is an effect that the stereo processing can be performed by effectively utilizing the number of pixels of the imaging element of the camera.

### Modified Example

Note that the embodiment above has been described in detail in order to describe the present invention to make it easier to understand, and is not necessarily limited to those having all the described configurations. For example, the range of imaging by the seven cameras illustrated in FIG. 5 is an example, and the number of cameras and the respective imaging angles may have other configurations.

Furthermore, in the example illustrated in FIG. 5, the entire periphery of the vehicle is imaged by seven cameras without a blind spot, but a configuration may be adopted in which some cameras are omitted and a part of the periphery of the vehicle is not imaged.

In this case, for example, a stereo processing system of the first camera group based on the front camera (the front narrow-angle camera or the front wide-angle camera) and a stereo processing system of the second camera group based on the rear camera may be prepared. In other words, the front camera and the rear camera having a relatively high resolution are preferentially set as the reference images, and the side cameras are corrected, so that the stereo processing can be performed effectively using the resolution of the camera similar to the above-described embodiment.

In addition, in the configuration diagram illustrated in FIG. 1, only control lines and information lines considered to be necessary for description are illustrated, and not all control lines and information lines on a product are necessarily illustrated. In practice, it may be considered that almost all the configurations are connected to each other.

Further, the on-vehicle image processing device 20 illustrated in FIG. 1 is an example in which each processing unit is configured on a computer by executing a program. The program in this case may be stored in a recording medium such as an external memory, an IC card, an SD card, or an optical disk and transferred to the computer (on-vehicle image processing device 20).

### REFERENCE SIGNS LIST

11 first camera (front narrow-angle camera)
12 second camera (front narrow-angle camera)
13 third camera (front-side camera)
14 fourth camera (front-side camera)
15 fifth camera (side-rear camera)
16 sixth camera (side-rear camera)
17 seventh camera (rear camera)
20 on-vehicle image processing device
20a CPU
20b memory
20c image input unit
20d interface
20e image output unit
21 image acquisition unit
22 image storage unit
23 subject recognition processing unit
24 image adjustment unit
25 image correction unit
26 image selection unit
26b second image selection unit
27 stereo recognition processing unit

1. An on-vehicle image processing device comprising:
an image acquisition unit that acquires images captured by a plurality of cameras mounted around a vehicle;
a first image correction unit that corrects an image deviation of an image captured by a second camera having a resolution lower than or equivalent to a resolution of a preset first camera among the plurality of cameras with reference to an image captured by the first camera among the plurality of cameras;
a first stereo recognition processing unit that performs stereo recognition processing using the image captured by the first camera and the image captured by the second camera corrected by the first image correction unit;
a second image correction unit that corrects an image deviation of an image captured by a third camera having a resolution lower than or equivalent to the resolution of the second camera with reference to the image captured by the second camera; and
a second stereo recognition processing unit that performs stereo recognition processing using the image captured by the second camera and the image captured by the third camera corrected by the second image correction unit.

2. The on-vehicle image processing device according to claim 1, wherein
the first camera is a front narrow-angle camera that is mounted in a front portion of the vehicle and has a first angle of view,
the second camera is a front wide-angle camera that is mounted in the front portion of the vehicle, has an imaging field of view partially overlapping with an imaging field of view of the front narrow-angle camera, and has a second angle of view wider than the one angle of view, and
the third camera is a front-side camera that is mounted on a side-front portion of the vehicle and has an imaging field of view partially overlapping with the imaging field of view of the front wide-angle camera.

3. The on-vehicle image processing device according to claim 1, further comprising:
a third image correction unit that corrects an image deviation of an image captured by a fourth camera having a resolution lower than or equivalent to a resolution of the third camera with reference to the image captured by the third camera; and
a third stereo recognition processing unit that performs stereo recognition processing using the image captured by the third camera and the image captured by the fourth camera corrected by the third image correction unit.

4. The on-vehicle image processing device according to claim 3, wherein
the first camera is a front narrow-angle camera that is mounted in a front portion of the vehicle and has a first angle of view,
the second camera is a front wide-angle camera that is mounted in the front portion of the vehicle, has an imaging field of view partially overlapping with an imaging field of view of the front narrow-angle camera, and has a second angle of view wider than the one angle of view,
the third camera is a front-side camera that is mounted on a side-front portion of the vehicle and has an imaging field of view partially overlapping with the imaging field of view of the front wide-angle camera, and
the fourth camera is a side-rear camera mounted on a side-rear portion of the vehicle and having an imaging field of view partially overlapping with the imaging field of view of the front-side camera.

5. The on-vehicle image processing device according to claim 4, further comprising:
a rear camera mounted on a rear portion of the vehicle;
a fourth image correction unit that corrects an image deviation of an image captured by the fourth camera having a resolution lower than or equivalent to the resolution of the rear camera with reference to an image captured by the rear camera; and
a fourth stereo recognition processing unit that performs stereo recognition processing using the image captured by the rear camera and the image captured by the fourth camera corrected by the fourth image correction unit.

6. The on-vehicle image processing device according to claim 1, wherein
the first camera, the second camera, and the third camera constitute a first camera group that captures images of a range from a front view to a side view from the vehicle,
a fourth camera and a fifth camera constituting a second camera group that captures images of a range from a rear view to the side view from the vehicle are further included, and
stereo recognition processing is performed on the images captured by the fourth camera and the fifth camera constituting the second camera group with reference to the image captured by the fourth camera or the fifth camera.

7. The on-vehicle image processing device according to claim 1, further comprising:
a recognition processing unit that performs distance measurement processing of an object around the vehicle based on two images on which stereo recognition processing has been performed by the first stereo recognition processing unit and the second stereo recognition processing unit.

8. An image processing method for on-vehicle equipment, the method comprising:
image acquisition processing of acquiring images captured by a plurality of cameras mounted around a vehicle;
first image correction processing of correcting an image deviation of an image captured by a second camera having a resolution lower than or equivalent to a resolution of a preset first camera among the plurality of cameras with reference to an image captured by the first camera among the plurality of cameras;
first stereo recognition processing of performing stereo recognition processing using the image captured by the first camera and the image captured by the second camera corrected by the first image correction processing;
second image correction processing of correcting an image deviation of an image captured by a third camera having a resolution lower than or equivalent to the resolution of the second camera with reference to the image captured by the second camera; and
second stereo recognition processing of performing stereo recognition processing using the image captured by the second camera and the image captured by the third camera corrected by the second image correction processing.
